(19) United States
(12) Patent Application Publication
(10) Pub. No.: US 2002/0059080 A1
(43) Pub. Date: May 16, 2002

(54) System, method, and user interface for managing intermediate healthcare facilities over computer networks

(76) Inventors: Robert Kasirer, Beverly Hills, CA (US); Florian Wieland, Laguna Hills, CA (US); James Koontz, Diamond Bar, CA (US); Steve Mayner, Marina del Rey, CA (US); Carl Strunk, Rancho Palos Verdes, CA (US)

Correspondence Address: MCDERMOTT, WILL & EMERY, 600 13th Street, N.W., Washington, DC, 20005-3096, US

(21) Appl. No.: 09/942,942

(22) Filed: Aug. 31, 2001

Related U.S. Application Data
(60) Provisional application No. 60/230,218, filed on Sep. 1, 2000.
(60) Provisional application No. 60/265,186, filed on Jan. 30, 2001.
(60) Provisional application No. 60/282,876, filed on Apr. 11, 2001.

(51) Int. Cl. G06F 17/60

(52) U.S. Cl. 705/2

(57) ABSTRACT

A variety of techniques are directed to providing services and technology to Intermediate Care Facilities, such as small rural hospitals, psychiatric institutions, nursing homes and assisted living facilities. An integrated suite of applications tailored to the needs of such Facilities is provided over a network from an application service provider. A central server provides links to vendors and ensures an integrated procurement process that enforces the rules of the particular facility.

### CROSS REFERENCE TO RELATED APPLICATIONS

This application claims priority from and is related to U.S. Provisional Application No. 60/230,218, filed Sep. 1, 2000, Attorney Docket Number 57177-013, and to U.S. Provisional Application No. 60/265,186, filed Jan. 30, 2001, with Attorney Docket Number 57177-016 and to U.S. Provisional Application No. 60/282,876, filed Apr. 11, 2001, with Attorney Docket Number 57177-017. The contents of each of those provisional applications are hereby incorporated by reference in their entirety.

### CROSS REFERENCE TO CD-ROM APPENDICES

This application contains an Appendix containing three (3) CD-ROMs, each containing instructions for implementations of various portions of the computer programs used to carry out the invention disclosed herein. The contents of the CD-ROMs are described in more detail in paper Appendix A attached to this document.

1. Field of the Invention

The present invention relates to managing Intermediate Care Facilities (ICF). More particularly, the present invention provides techniques, systems, methods, and user interfaces for managing such Intermediate Care Facilities over computer networks.

2. Background of the Invention

The health care industry is comprised of a large number of organizations and facilities that vary widely in technical sophistication and capability from the well organized, well staffed and well funded acute care facilities; to individual Doctor's offices; and, in between, to Intermediate/Long Term Care Facilities such as small rural hospitals, psychiatric institutions, nursing homes and assisted living facilities. The latter facilities shall be referred to as Intermediate Care Facilities throughout the remainder of this document.

Providers of goods and services (sometimes referred to as Vendors) to the healthcare industry have a similar range of size and sophistication.

Long-term care facilities in the United States generally fall into one of two categories: (i) skilled nursing facilities (SNFs), for residents frail and ill enough to require continuous nursing attention, but not so acutely ill as to require hospitalization; and (ii) assisted living facilities (ALFs), for residents unable to cope with the activities of daily living on their own, but who do not require continuous nursing attention.

In 1999, approximately $120 billion was spent on care in SNFs, a figure which has been growing at an annual rate of about 10% for at least the last decade. The industry briefly consolidated during the mid-1990s, with the top ten SNF chains (including Beverly, Vencor, ManorCare, Integrated, Mariner, Sun, Genesis, and Lenox) accounting for about 20% of industry revenues. With the passage of the 1997 Balanced Budget Act, however, the Federal government imposed significantly stricter reimbursement policies for Medicare residents, the source of between 25% and 40% of most chains' revenues (an additional 25-50% of revenue generally coming from the Medicaid program). As a result, many of the larger chains have been unable to meet debt obligations which they incurred to pay for acquiring additional facilities and ancillary businesses, and a significant number of bankruptcies have occurred, with five of the largest seven chains (and 1,651 of approximately 17,200 homes nationwide) now in receivership. Even so, with occupancy rates exceeding 90% at most homes, industry experts have described this situation as a mere restructuring, rather than a permanent industry setback.

In California, state figures report that about $62 per bed per day was spent on products and services supplied by various third-party suppliers and service vendors, including rehabilitation and administrative overhead, capital costs and financing costs. The remainder was spent on labor and direct resident care. A brief listing of the basic products and services required to run even a mid-sized SNF will demonstrate the complexity involved in managing an intermediate healthcare facility. These products and services include, at a minimum:

Dietary supplies (meat, dairy, grocery and produce)

Housekeeping supplies

Laundry and linen supplies

Enteral supplies and supplements (e.g., G, J and NG tubes, Ensure, Sustacal)

Ostomy supplies

Oral pharmacy (averaging 5 prescriptions per resident per month, with many residents taking as many as 12 medications per day)

IV therapy (including total parenteral nutrition [TPN], antibiotic therapy, pain management and hydration)

Wound care (including special mattresses, ointments and wound dressings to prevent or treat bedsores, as well as wound care consulting services)

Durable medical equipment (including wheelchairs, walkers, canes and prostheses)

Medical supplies

Radiology (portable x-ray) services

Laboratory services

Rehabilitation services (including physical therapy, occupational therapy, and speech pathology)

Respiratory therapy (including oxygen and related equipment and supplies)

Power and utilities (electricity, gas, cable, telephone and IT services)

Grounds keeping, repair and other property, operations and maintenance services

Social services

Resident activities

Because the amount spent on many of these products and services varies significantly on a weekly basis (such as rehabilitation services, emergency medical supplies, radiology and laboratory exams, and food & medications, among others), while the amount spent on other items can remain unchanged for months at a time (e.g., utilities, routine resident supplies, resident activities, housekeeping), a “usual” number of transactions per resident per week per facility can be difficult to establish. However, a reasonable estimate is approximately 10-15 transactions per resident per week, about 6-7 of which occur in the eight key areas representing nearly 80% of the total dollar volume involved: four service areas—pharmacy, laboratory, radiology, and rehabilitation; and four product areas—dietary and housekeeping supplies; durable medical equipment, respiratory and medical supplies; specialty beds and wound care supplies; and enteral and ostomy supplies.

While spending on information technology has lagged throughout the healthcare sector, rarely exceeding 5% of revenues (vs. more than 12% in financial services, for example), the long-term care segment has historically been an area which particularly under-invested in information technology. Many facilities and chains had no computers at all until the Health Care Financing Administration (HCFA) began requiring on-line transmission of the Minimum Data Set (MDS) information, discussed more hereinafter, during the late '90s. The computers generally acquired at that time are simply unable to manage the level of information complexity and on-line access required by today's integrated software packages. At the same time, the operating environment for skilled nursing facilities and other long-term care institutions has rapidly become one of the most complex faced by any industry segment across the entire economy.

There are currently 4,956 community-based acute-care medical/surgical hospitals in the United States, including approximately 600 psychiatric hospitals. Total spending at these hospitals was nearly $320 billion in 1998, the latest year for which figures are available. The average daily census was 526,000, with approximately 820,000 beds available.

Compared to SNFs, small hospitals tend to spend more money on labor and administration, and somewhat less on procurement—although absolute spending on goods and services by small hospitals is more than double that accounted for by SNFs.

Because of the Balanced Budget Act of 1997 (BBA), large acute-care hospitals have cut spending dramatically, as they seek to offset nearly $36 billion of reduced Federal Medicare and Medicaid reimbursements. Small hospitals, however, have been granted a safe harbor by the Balanced Budget Refinement Act of 1999, which granted an additional $1.3 billion specifically to these facilities, with much of the funding earmarked for improvements in information technology. In addition, small and rural hospitals with 100 or fewer beds have been held harmless with respect to their pre-BBA funding levels until at least 2004.

About $20 billion was spent on (Assisted Living Facilities (ALF) care in 1999, with the top 30 companies involved in the sector (including Marriott, Sunrise, Alterra, Atria, Emeritus, Holiday, Assisted Living Concepts and American Retirement Corp.) accounting for only about 4% of revenues in a remarkably fragmented industry. Over 95% of ALF residents are private pay.

Many states do not require ALFs to obtain state certification in order to operate (although this is beginning to change and many states are introducing certification requirements and more are expected to join the fold). Therefore, ALFs generally do not have to meet the same level of operating standards as SNFs and thus, are considerably easier to run (with only 10-15 major suppliers and service vendors per facility, compared with 20-25 for a SNF).

The California Association of Healthcare Facilities (CAHF) 2000 guidebook lists over 125 separate categories of product and service vendors to skilled nursing facilities, ranging from Accounting to X-Ray. While a precise count of vendors nationwide is impossible, due to overlap with other businesses which also purchase food service or housekeeping, a conservative estimate would place the number of vendors to the intermediate healthcare industry at more than 75,000, or nearly 8 separate vendors per facility. Since there is substantial overlap between vendors and facilities, each facility actually deals with 15-20 vendors on a regular basis, and substantially more on occasion (e.g., for new employee background checks).

### SUMMARY OF THE INVENTION

The invention is directed to methods of providing services to and upgrading information technology capabilities at Intermediate Care facilities.

The invention helps manage the spectrum of intermediate care and long-term care procurement transactions, and tightly integrate these transactions into an overall management, financial, accounting and billing system. Even more importantly, the invention provides compliance feedback, both procurement and clinical, helping the system run smoothly and more efficiently and helping deliver higher quality and more profitable patient and resident care.

While many of these vendors are large, national firms (such as SYSCO, for food), others are regional or even only municipal in scope. Directly enrolling such a dispersed customer base would be prohibitively expensive, so, in accordance with the invention, vendors are enrolled in conjunction with the enrollment of their customers. Furthermore, since using the CentraLink system is both affordable and efficient for vendors, larger service and product suppliers will act to enroll their facility customers in CentraLink's network, creating a positive cycle of enrollment and helping to drive market penetration.

The foregoing and other features, aspects and advantages of the present invention will become more apparent from the following detailed description of the present invention when taken in conjunction with the accompanying drawings.

### BRIEF DESCRIPTION OF THE DRAWINGS

The objects, features and advantages of the system of the present invention will be apparent from the following description in which:

FIG. 1 is a drawing of facility needs, vendor needs and the parameters of a solution in accordance with one aspect of the invention.

FIG. 2 is a block diagram of a system architecture for carrying out one aspect of the invention.

FIG. 3 is a block diagram of a network arrangement suitable for implementing the invention at an Intermediate Care Facility or at a vendor facility.

FIG. 4 is a block diagram illustrating the hardware and software architecture of a workstation such as might be used in implementing the arrangement of FIG. 3.

FIG. 5 is an exemplary hardware architecture for implementing a Central Server such as shown in FIG. 2.

FIG. 6 is a block diagram of an exemplary application software architecture of a server implementation in accordance with another aspect of the invention.

FIG. 7 is a block diagram of an exemplary software implementation of an Acute Care Subsystem of application programs as shown in FIG. 6.

FIG. 8 is a block diagram of an exemplary software implementation of a Financial and Accounting Subsystem of application programs as shown in FIG. 6.

FIG. 9 is a block diagram of an exemplary software implementation of an Intermediate Care Subsystem of application programs as shown in FIG. 6.

FIG. 10 is a high level flow chart of an exemplary process for ordering supplies and services.

FIG. 11 is a high level flow chart of an exemplary process for shipping supplies and delivering services.

FIG. 12 is a high level flow chart of an exemplary process for converting MDS data into a searchable database for identifying potential clinical trial candidates and for determining product utilization.

FIG. 13 is an illustration of a rules hierarchy for illustrating rules inheritance in accordance with one aspect of the invention.

FIGS. 14A and 14B illustrate high level information flow before and after implementation of the invention, respectively.

FIG. 15 is a representation of exemplary benefits provided to users in accordance with one aspect of the invention.

FIG. 16 is a diagram showing high level information flow using the central server.

FIG. 17 is a block diagram showing the relationship among subsystem modules in accordance with one aspect of the invention.

FIG. 18 is a block diagram of an Integrated Compliance Program in accordance with one aspect of the invention.

FIG. 19 is a block diagram of an exemplary Information Flow through a procurement process in accordance with one aspect of the invention.

FIG. 20 is a comparison of selected features of the invention against application service providers of the prior art.

### DETAILED DESCRIPTION OF THE INVENTION

Applicants have recognized that Intermediate Care Facilities share certain common problems that permit a solution to be crafted that can be adapted to the culture of each individual institution while still accommodating the needs of the universe of Intermediate Care Facilities.

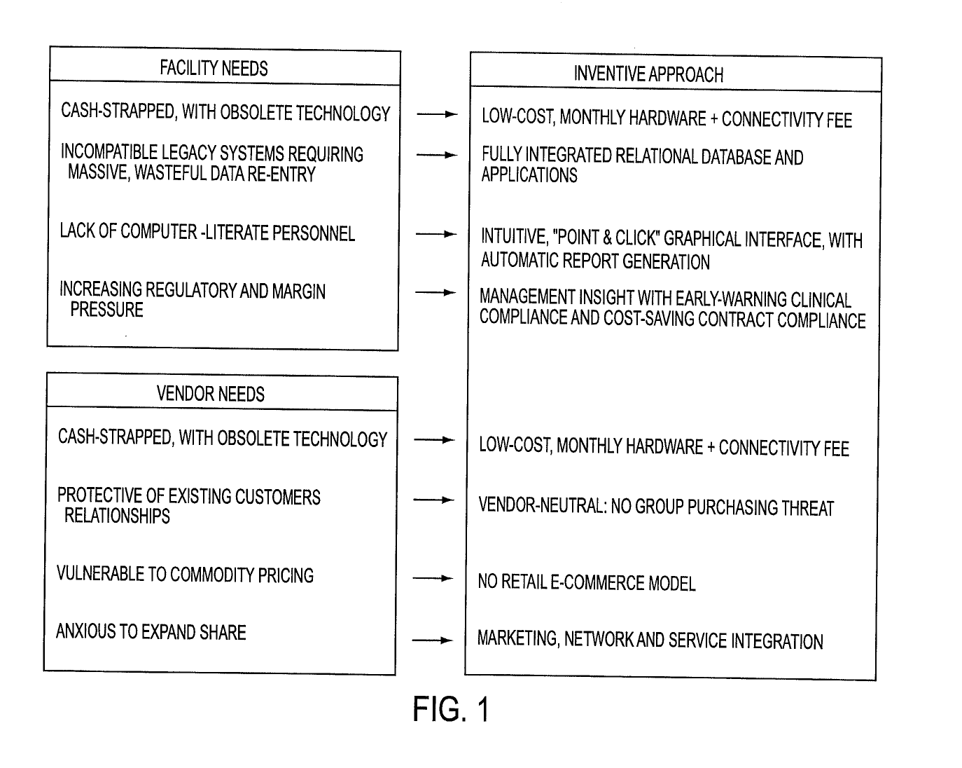

FIG. 1 is a drawing of facility needs, vendor needs and the parameters of a solution in accordance with one aspect of the invention. As illustrated in FIG. 1, Intermediate Care Facilities (ICFs) are typically cash strapped, with obsolete technology. They possess a variety of dated and certainly incompatible legacy systems requiring massive, wasteful redundant data entry. ICFs typically lack computer literate personnel. As described more hereinafter, ICFs are facing increasing regulatory and margin pressures. Many facilities and chains had no computers at all until HCFA began requiring on-line transmission of the MDS in the late '90s, and the computers generally acquired at that time are simply unable to manage the level of information complexity and on-line access required by today's integrated software packages.

Vendors to the healthcare industry face some similar pressures. As also illustrated in FIG. 1, they too, are cash strapped and have obsolete technology. They are protective of existing customer relationships and are sometimes fearful that automated solutions will displace them from the customer relationships they have carefully built. They are aware that many of their goods and services have become commodities that can be provided by others willing to compete on price. At they same time they are anxious to increase their share of the market.

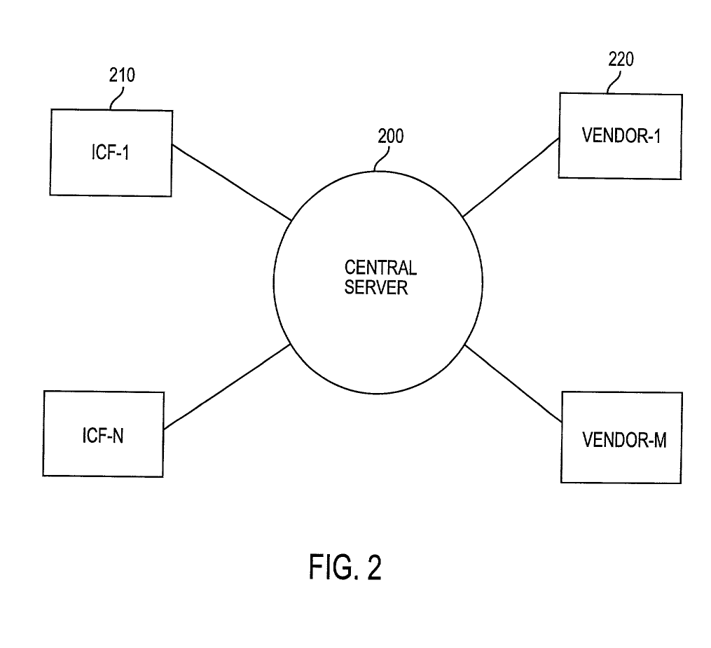

FIG. 2 is a block diagram of a system architecture for carrying out one aspect of the invention. Item 200 represents the Central Server which interlinks a plurality of Intermediate Care Facilities 210 and a plurality of vendors 220. Although the Intermediate Care Facilities and vendors are shown connected to the Central Server and a star architecture, any type of network connection, for example, token ring, can be utilized to connect the Intermediate Care Facilities 210, vendors 220 with a Central Server 200. In a preferred embodiment, the connection between the individual Intermediate Care Facilities and vendors to the Central Server occurs over a virtual private network.

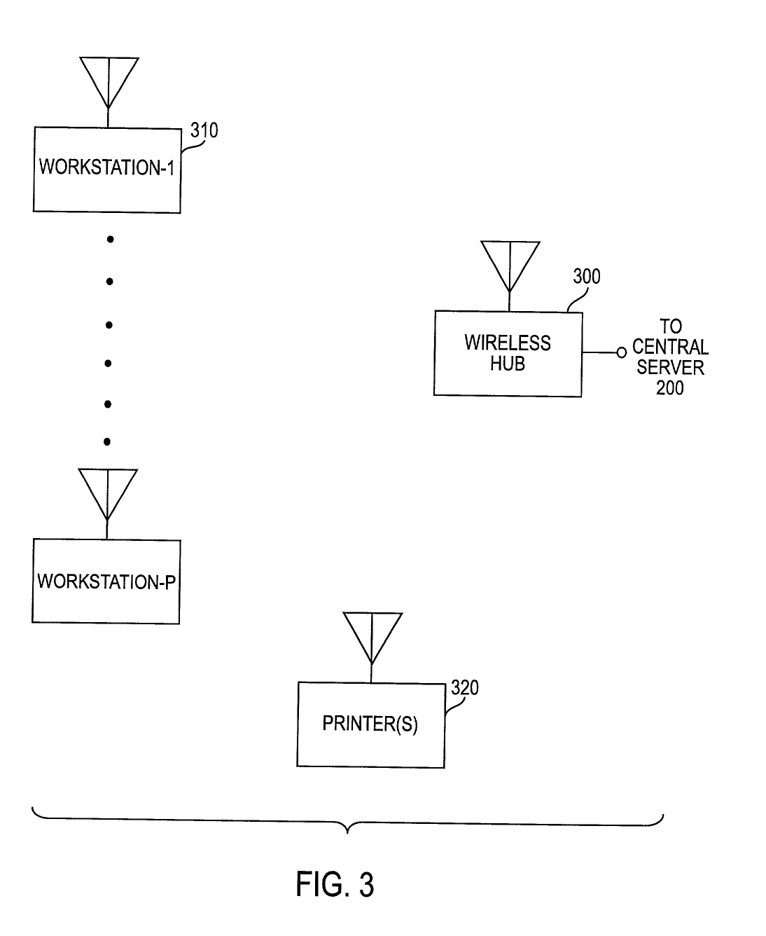

FIG. 3 is a block diagram of a network arrangement suitable for implementing the invention at an Intermediate Care Facility or at a vendor facility. As shown in FIG. 3, a workstation configured as a wireless hub 300 connects to the Central Server 200 over a network. The wireless hub service is a central node for a wireless local area network interconnecting a plurality of workstations 310 with the Central Server over the wireless hub. The wireless hub also interconnects the workstations 310 with one or more printers 320. The wireless LAN is preferred in most environments where cabling for an existing network is inadequate to support the installation of the invention. Using wireless LANs permits one to avoid the cost of installing a new wiring plant. In installations where the existing network cabling is sufficient to support LAN operation over optical or over conductive-based medium such as coax or copper, the workstations 310 can be linked to the network control workstation 300 using standard networking technology. A configuration very similar to that shown in FIG. 3 is utilized at vendor installations except that typically, a vendor installation will require fewer workstations.

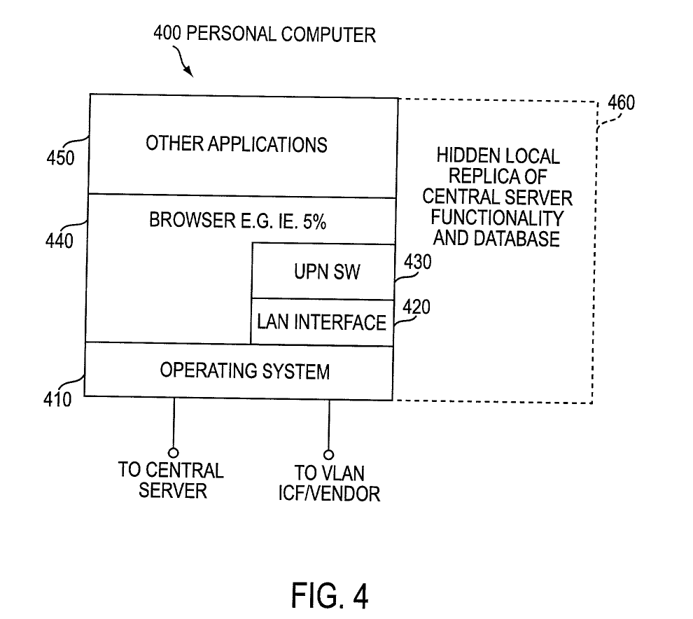

FIG. 4 is a block diagram illustrating the hardware and software architecture of a workstation such as might be used in implementing the arrangement of FIG. 3. In FIG. 4, personal computer 400 is a workstation of, for example, the Intel Pentium Class. Such a workstation has an operating system 410 which, in one embodiment is comprised of the Windows 2000 operating system. It also includes a local area network interface 420 and virtual private network software 430 to enable the workstation to link to the Central Server in a secure manner. A browser 440, which could in a particular implementation be an Internet Explorer type browser, provides the principal interface to the user when connecting to the Central Server. The variety of other applications 450 may be installed to suit the personal needs of the user of personal computer 400. When the interconnection that an Intermediate Care Facility or a vendor orders is a wireless LAN connection, the LAN interface 420 will be a wireless LAN interface. When it is a standard network interface, it will be a non-wireless LAN interface. When the personal computer 400 is configured to be the main connection point with the Central Server, the computer is additionally optionally equipped with a hidden local replica 460 of the Central Server functionality and database to permit the terminals at the Intermediate Care Facility to function, notwithstanding the link to the Central Server might go down. If, in fact, the Central Server goes down, the individual terminals can continue to operate with the hidden local replica until such time as the link is restored. At that time, the Central Server will synchronize the Central Server database with the transactions and information that has been stored in the hidden local replica and the information at the Central Server will thereafter be updated in real time.

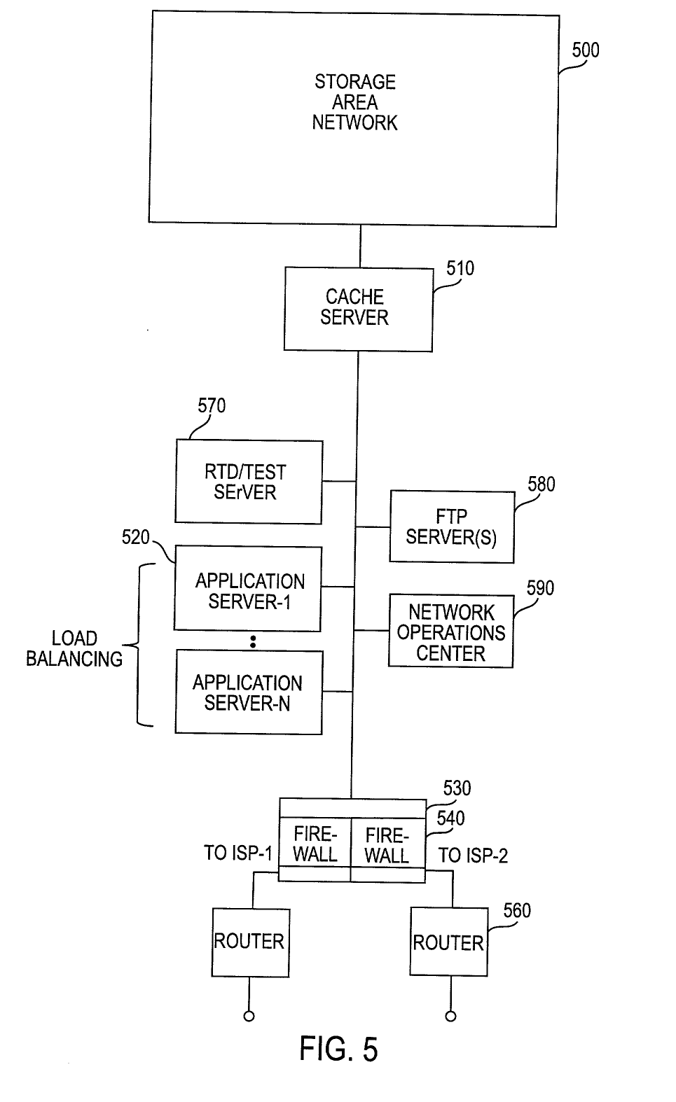

FIG. 5 is an exemplary hardware architecture for implementing a Central Server such as shown in FIG. 2. Storage area network 500 comprises a plurality of Compaq DV580 servers running Microsoft SQL 2000 server software. They are connected in any one of several feasible configurations to constitute the storage area network. The interface between the storage area network and the main network 515 is through cache server 510. The cache server 510 stores replicas of pages within the storage area network to facilitate their rapid retrieval if they are used more than once in a well-known fashion.

A plurality of application servers 520 operate in a load sharing mode and provide services to users over the network 515. The interface to the network from the external world is fully redundant. The interface server 530 maintains separate firewalls 540 going to separate ISPs over ISP interfaces 550. The ISPs are connected via separate routers 560 and by separate physical paths maintained by separate carriers. The application servers are typically compact DV360 class dual processor class of devices running Windows 2000 operating system and Microsoft application server software. Services are delivered to end users utilizing Citrix server software on the Central Server side and by using a Citrix client on the individual workstations of the vendors and Intermediate Care Facilities. An R&D/test server environment 570 is maintained to enable new software implementations to be tested without impacting operational functionality. FTP servers 580 permit materials to be received and downloaded from end user workstations utilizing File Transfer Protocol. A network operation center contains overall system management software such as Syslog, Link Tools, Compaq Instant Manager, Net IQ, Wats Up and RMS Console. Any number of network maintenance and observation tools may be utilized to ensure the network is up and running and fully functional at any particular point in time.

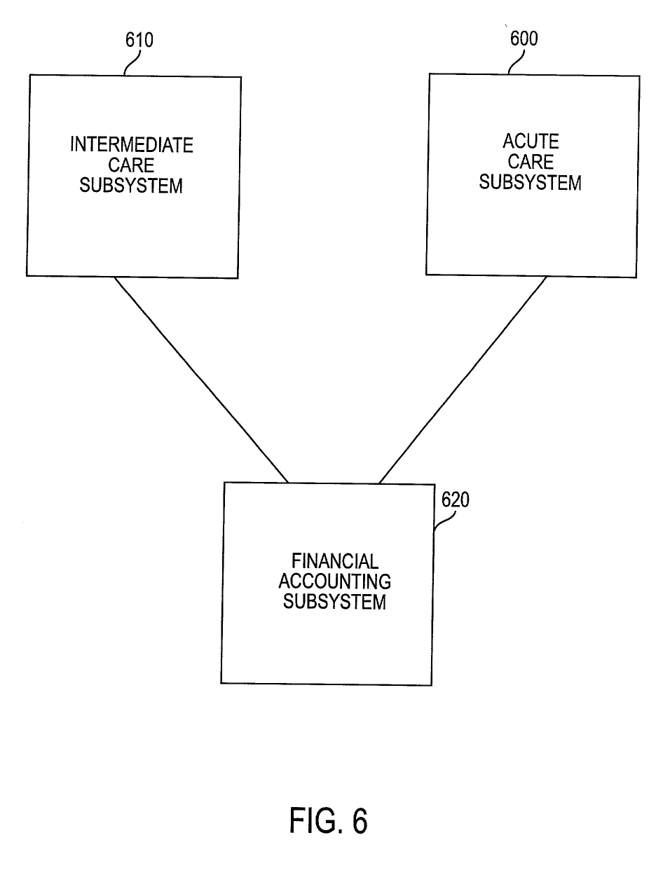

FIG. 6 is a block diagram of an exemplary application software architecture of a server implementation in accordance with another aspect of the invention. The software architecture for the Central Server hardware described in conjunction with the previous Figure comprises three subsystems. The Acute Care Subsystem 600 is dominated with that nomenclature because it shows in common some functionality required by Acute Care Institutions. However, the invention is directed to the Intermediate Care Facility market and not to the Acute Care Market. The Intermediate Care Subsystem 610 contains assertive software to be described hereinafter as those the financial/accounting subsystem 620.

Each of these subsystems will be described more hereinafter and is described in detail in the CD ROM Appendices attached hereto.

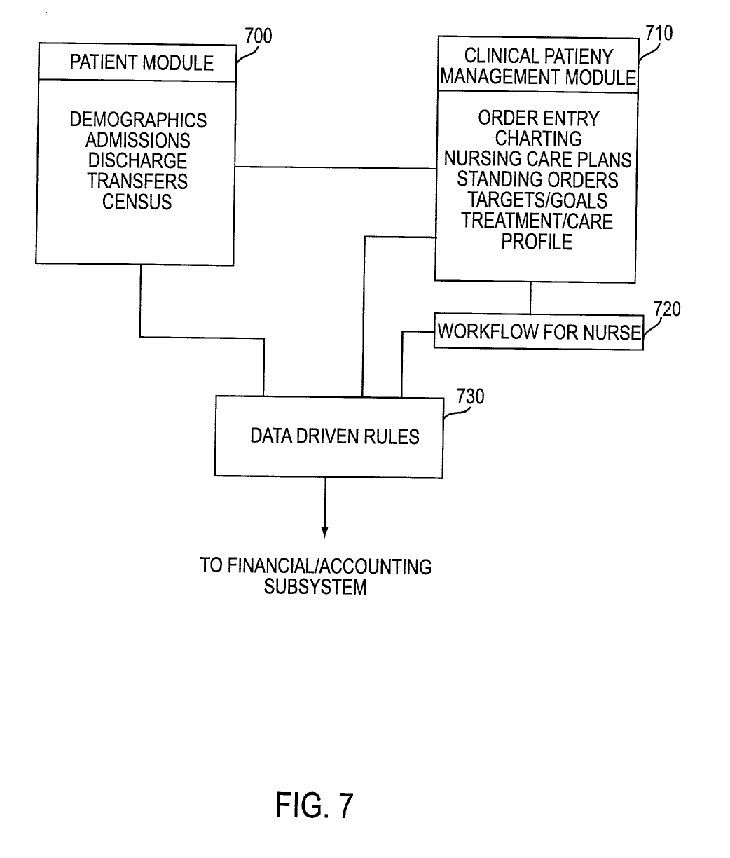

FIG. 7 is a block diagram of an exemplary software implementation of an Acute Care Subsystem of application programs as shown in FIG. 6. The Acute Care Subsystem comprises a patient module 700 which deals mainly with the demographics, admissions, discharge, transfer and current census of patients within the Intermediate Care Facility. The clinical patient management module 710 includes software for allowing a physician to enter orders with respect to a patient, for charting a patient, for creating nursing care plans, for entering and recording standing orders, for providing targets and goals for a patient's care and for providing a treatment care profile. The information in this module is utilized to create a workflow for a nurse assigned to care for a particular patient and to aggregate the information for a particular patient with that of other patients assigned to the care of that nurse so that the nurse has an integrated view of the workflow needed to carry out the proper care of patients within her jurisdiction. This is a rules based system and the data entered by the various modules results in triggering appropriate rules which implement the functionality. The exemplary rules for carrying out the invention are shown in the attached CD ROM Appendices. In addition to generating the workflows for a particular nurse, the rules based system also provides output to the financial and accounting subsystem so that appropriate billing and payment can be accounted for.

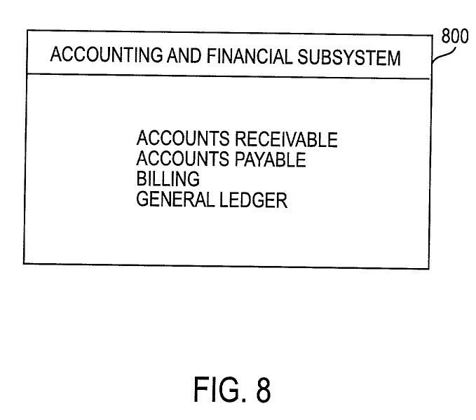

FIG. 8 is a block diagram of an exemplary software implementation of a Financial and Accounting Subsystem of application programs as shown in FIG. 6. The financial/accounting subsystem comprises a plurality of modules such as accounts receivable, accounts payable, billing, general ledger and the like, which are routine and well-known in the healthcare industry.

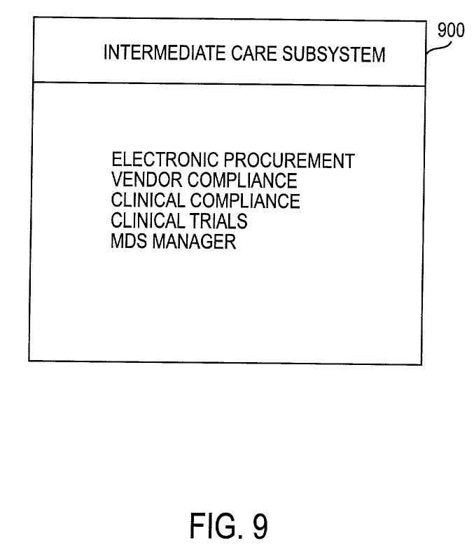

FIG. 9 is a block diagram of an exemplary software implementation of an Intermediate Care Subsystem of application programs as shown in FIG. 6. The Intermediate Care Subsystem includes a variety of software modules including electronic procurement, vendor compliance, clinical compliance, clinical trials, and MDS Manager. These modules are described more hereinafter and in the associated CD ROM Appendices attached hereto.

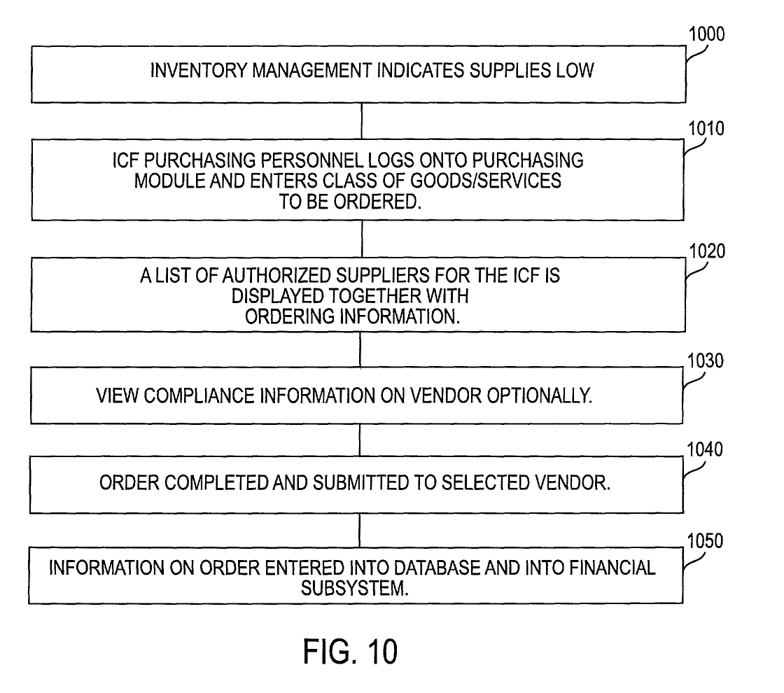

FIG. 10 is a high level flow chart of an exemplary process for ordering supplies and services. This flowchart describes a process which can be utilized to order supplies or services. At step 1000, an optional check of the inventory management subsystem indicates that supplies are low. Alternatively, a rule may fire when an item in inventory reaches a threshold level, alerting a user that an order needs to be placed. At step 1010, Intermediate Care Facility purchasing personnel logs into the purchasing module and enters a class of goods or services to be ordered. A list of authorized suppliers for the Intermediate Care Facility is displayed together with ordering information at step 1020. Optionally, step 1030, the ICF ordering personnel can view the compliance information on a particular vendor and compare the compliance information with other vendors who supply the same goods or services to determine the appropriate destination for the order. Once the order is completed, step 1040, the ordering information is submitted by the selected vendor and the compliance information updated. In step 1050, that information on the status of the order entered in the database and/or the financial subsystem to prevent appropriate billing and payment records to be generated.

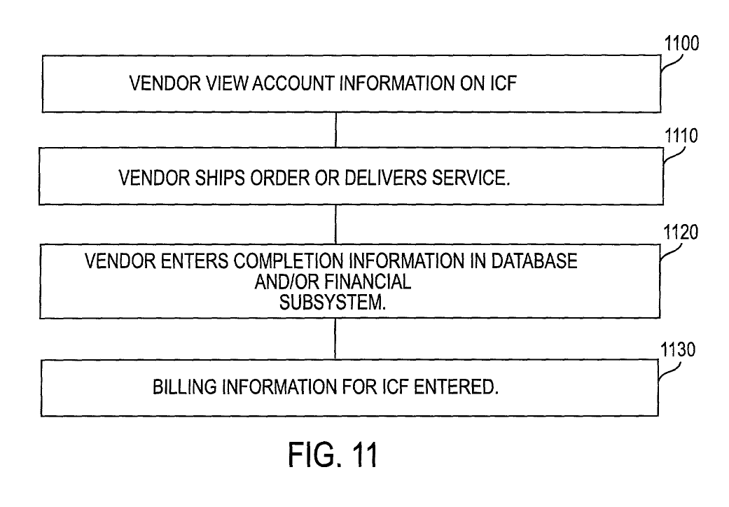

FIG. 11 is a high level flow chart of an exemplary process for shipping supplies and delivering services. Before shipping an order or providing services, the vendor may optionally view the account information status of the Intermediate Care Facility (step 1100). If appropriate, the vendor ships the order or delivers the service (1110). The vendor then enters completion information in the database and/or the financial subsystem (1120) and enters appropriate billing information for the ICF (1130).

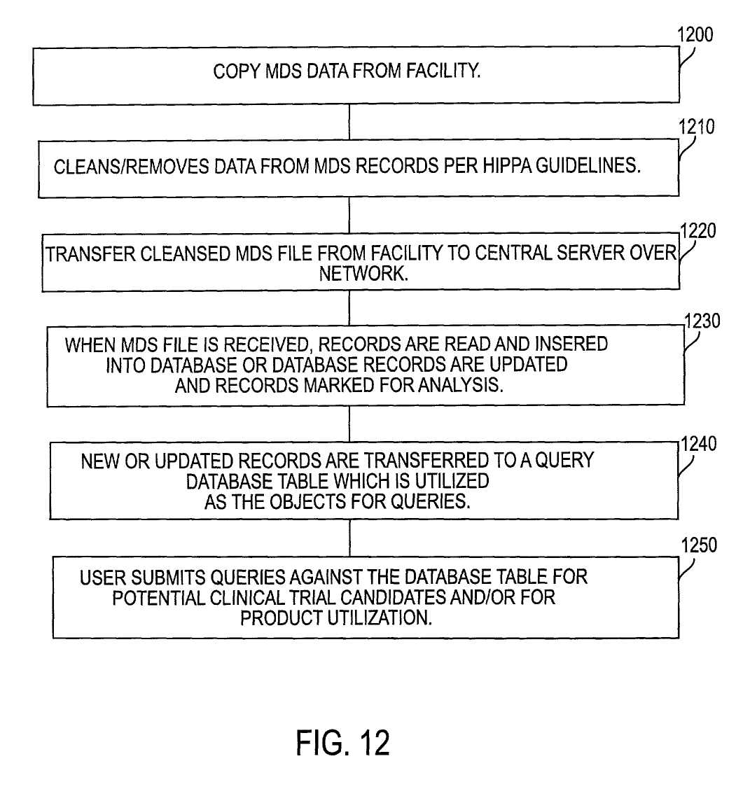

FIG. 12 is a high level flow chart of an exemplary process for converting MDS data into a searchable database for identifying potential clinical trial candidates and for determining product utilization. At the ICF, a copy of the MDS data from the facility is made (1200) and cleansed or sanitized to remove data from the MDS records or hit the guidelines (1210). The cleansed MDS file and transferred from the facility to the Central Server over a network (1220) and when the MDS file is received at the Central Server (1230), the individual's records are read and inserted into a database where database records are updated and records are marked for analysis.

The more updated records are transferred to a query database table which is utilized as the object for information retrieval queries by users (1240). A user can then query the query database table for potential clinical trial candidates and/or for product utilization (1250).

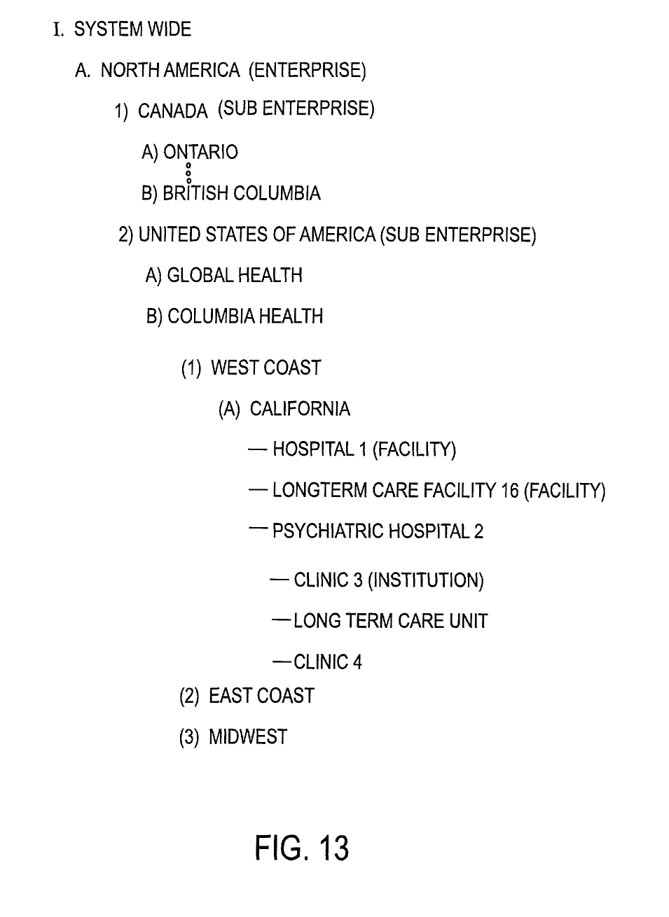

FIG. 13 is an illustration of a rules hierarchy for illustrating rules inheritance in accordance with one aspect of the invention. The rules utilized to implement the invention eacg have a scope of application. Rules at a lower level in the hierarchy may inherit characteristics of rules higher in the hierarchical level. For example, as shown in FIG. 13, a plurality of rules may have system-wide application. These rules may be inherited by a variety of enterprises and sub-enterprises. For example, North America may constitute an enterprise having two sub-enterprises of Canada and the United States. Canada, having a socialized healthcare system, divides the enterprises by province so that each province, as a sub-sub enterprise, may have its own rules.

In the United States of America, on the other hand, the rules may be unique to a particular healthcare enterprise, such as Global Health or Columbia Health, illustrated in FIG. 13. Columbia Health, for example, may have East Coast and West Coast sub-sub-enterprises and the West Coast sub-sub-sub-enterprise may have a sub-sub-sub-sub-enterprise for California having a plurality of facilities such as hospital 1 and long-term care facility 16 and psychiatric hospital 2. The facilities may each have a plurality of institutions within the facilities, such as a long-term care unit, clinic 3 and clinic 4 for psychiatric hospital 2. In short, local rules at any level of the hierarchy may be instantiated by inheritance from rules above or may be customized for the institution, facility or enterprise level with which they are associated.

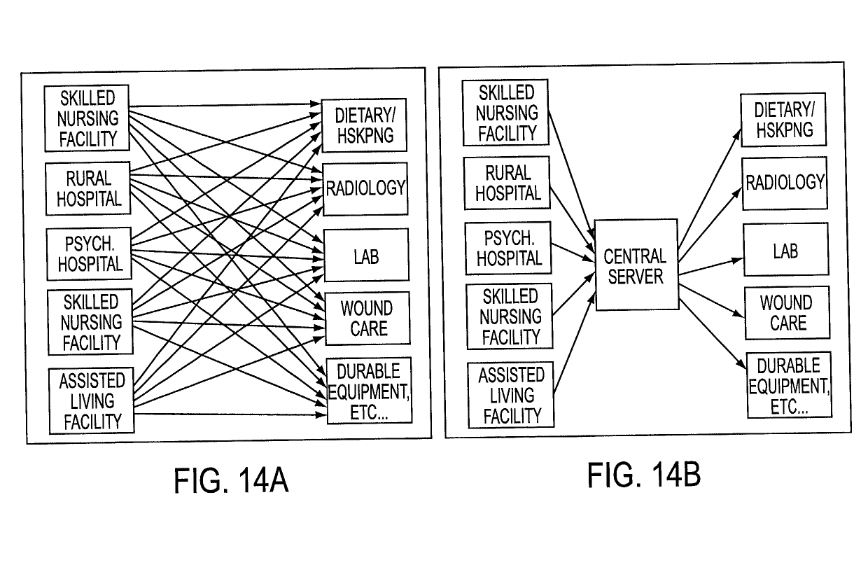

FIGS. 14A and 14B illustrate at a high level procurement information flow before and after implementation of the invention.

According to the Gartner Group, electronic business-to-business procurement is likely to increase from $145 billion in 1999 to over $7.3 trillion in 2004. While other researchers offer somewhat lower numbers (such as $3.0 trillion in 2004, according to the Yankee Group), the e-procurement opportunity is undoubtedly large across industries. Simply by reducing the rogue purchasing associated with antiquated catalog and paper-based procurement, many companies (including intermediate healthcare facilities) have discovered that they can immediately decrease costs between 5 and 15%. For some facilities and chains, the number has proved to be as high as 20-40%. Furthermore, many of the personnel ordering resident and institutional goods in the intermediate healthcare setting now do so with inadequate training, with inadequate or contradictory resident information, and with significant under-staffing. By hard-wiring sensible procurement choices into the options presented to these personnel, the invention's convenient, reliable and comprehensive ordering system enforces pre-established formularies and contracting criteria, and creates substantial value both for facilities and vendors.

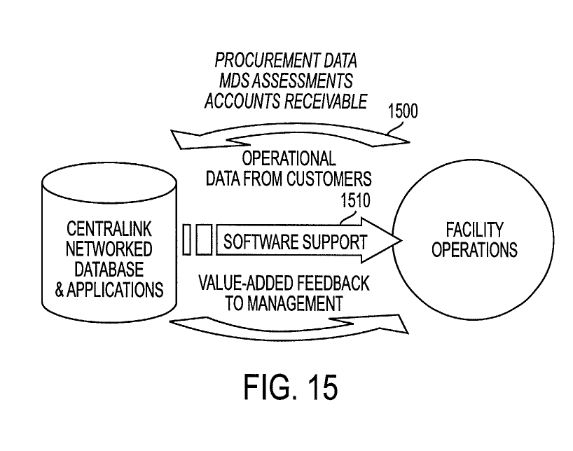

FIG. 15 is a representation of exemplary benefits provided to users in accordance with one aspect of the invention. As shown in FIG. 15, data from facility operations is sent (1500) to the Central Server. The Central Server provides software support (1510) to the facility operations. The Central Server processes the operational data from the facilities and provides a variety of value added feedback to management about the operation of the facility and about compliance by vendors and about clinical compliance, thus optimizing the income from the facility and optimizing compliance with external regulations to minimize administrative difficulties from regulators.

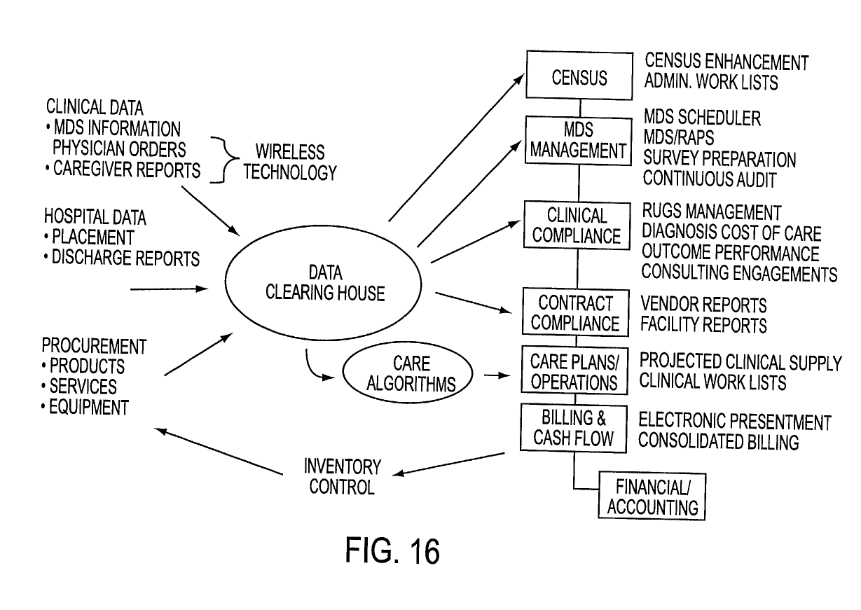

FIG. 16 is a diagram showing high level information flow using the central server. Some benefits to the facility utilizing the Central Server as shown in more detail in FIG. 16. Clinical data, hospital data and procurement data are all provided to the Central Server. On the facility side, modules track census, MDS management, clinical compliance, contact compliance, generate care plans, create operational scenarios and provide billing and cash-flow information to a financial/accounting module and back to the central control where the inventory status is monitored permitting the procurement cycle to be initiated appropriately when supplies or services are low.

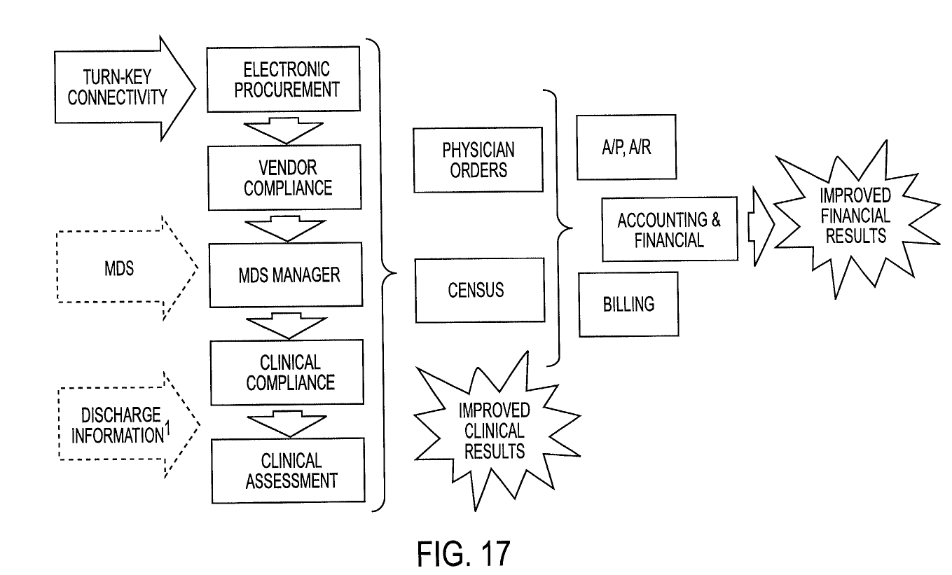

FIG. 17 is a block diagram showing the relationship among subsystem modules and revenue streams in accordance with one aspect of the invention.

Three key factors enable the invention to offer this comprehensive solution to its customers and users. First, the intermediate healthcare market is significantly less complex than the acute care market, where integrators have repeatedly tried and failed to master the overwhelming complexity of the sector. By contrast, intermediate healthcare facilities rely on well-established algorithms to monitor operations compliance, contract compliance, and the associated accounting and billing tasks. Thus, the integration task within this market is more like that in the traditional small and medium-sized enterprise (SME) market, where integration has been routinely successful, than the acute care market, where integration has for the most part failed.

Second, the purchasing decision in intermediate healthcare is significantly less complex than in the acute healthcare environment. Particularly in stand-alone facilities and small chains, the facility owner or empowered administrator is responsible for nearly all procurement, including management information systems.

Finally, the invention focuses on maintaining the linkages and integration between modules, rather than on developing the modules themselves.

Connectivity fees are one source of revenue. The invention provides a fully-operational hardware, software and networking package to its facility and vendor customers for one low monthly fee, with no up-front investment costs. Market research has shown that facility customers will generally need an average of five (5) workstations, supplemented by one hard-copy printer, a wireless hub, a local router and a high speed (e.g. DSL) connection. Vendors will generally require a similar arrangement, but with only two (2) workstations. Using hardware, software and networking and support services supplied by strategic partners, the entire package can be offered to facilities for a nominal monthly cost.

An addition revenue stream comes from facility and vendor subscriptions for access to core ASP productivity applications. These applications can be offered according to a cafeteria plan, with several levels of service and associated price. The most basic level of service one can offer to facilities comprises an electronic procurement and contract compliance monitoring applications. The next level of service includes operations compliance monitoring, MDS manager and census manager applications can be added, for an additional amount per month. Finally, facilities may opt for physician order and clinical assessment applications, available for an incremental amount per month. The full ASP management package is available to skilled nursing facilities for an amount well within most administrative budgets.

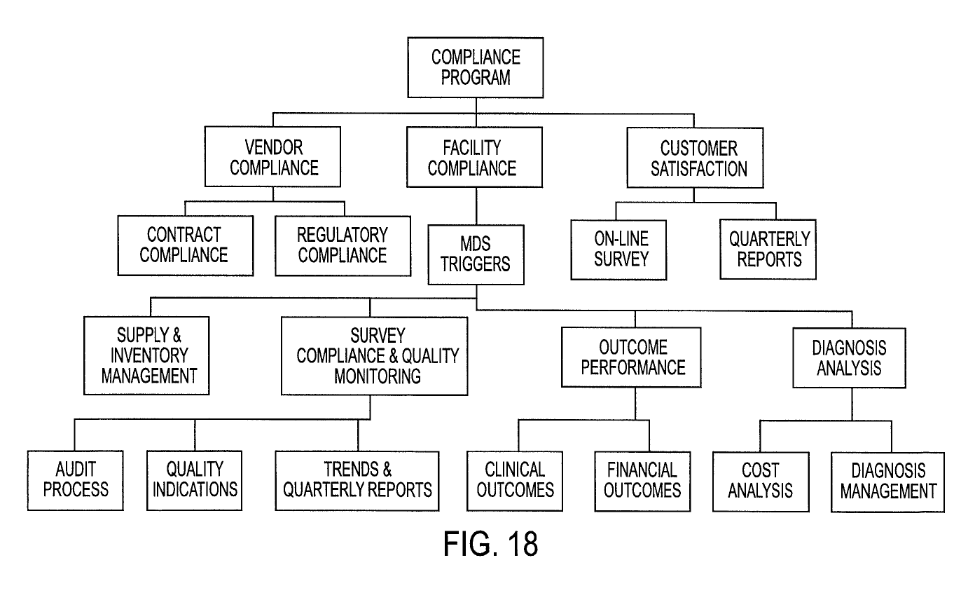

FIG. 18 is a block diagram of an Integrated Compliance Program in accordance with one aspect of the invention. Given the demanding nature of healthcare, both contract and operations compliance have long been significant problems for facility administrators. Vendor pricing can routinely vary by up to 80% per SKU (stock-keeping unit), depending on the terms and conditions of a given contract, and persistent confusion among high-turnover staff members usually guarantees that contract compliance as to the terms and conditions of service is often somewhat of a mystery. Because of the wide variability of SKU pricing, the vendor or “contract” compliance monitoring system does not offer full pricing transparency to facility staff, unless requested, but merely checks that the pricing of items within a given contract adheres to that contract's guidelines and specifications. The compliance system also monitors the terms and conditions of services promised against services actually delivered, so that facilities and vendors are better able to understand and measure value at the time contracts are re-negotiated—for example, in determining the window of time during which a “stat” order has actually been delivered. This level of transparency is carefully crafted to benefit both facilities and vendors, since facilities will now have access to an on-going record of actual vendor performance, while high-quality vendors will now be able to rely on an independent record which demonstrates their high quality contract compliance performance.

An even more important recent driver of change in the healthcare industry has been the need for demonstrated clinical (operations) compliance, both in processes and outcomes. Health department surveyors in most states are authorized to impose a $10,000 fine per instance for any regulatory violation by a skilled nursing facility, and are even authorized to place a facility in immediate receivership, if the situation warrants. Particularly in California, where health department surveyors issue about twice the national average of skilled nursing facility deficiencies, quality of care and regulatory compliance are of the highest priority for every facility administrator. In the same way, JCAHO violations can be critically expensive for small and rural hospitals and psychiatric institutions—precisely where the resources to prepare for surveys are least available and violations most likely to occur.

In order to gather and maintain information on the physical and mental condition of skilled nursing facility residents, HCFA has created and implemented the Minimum Data Set (MDS), a resident survey instrument that contains 1,800 fields representing 300 demographic and assessment items. In addition to monitoring residents' clinical status, this instrument assists HCFA in determining the specific resource utilization group (RUG) into which a resident will be placed, and accordingly the level of payment that a SNF will receive.

Both Federal and state governments have begun using HCFA's MDS data to prompt nursing facility surveys, and have significantly increased their funding for surveyors (to over $71 million nationally in 1997 (up 21%), and to more than $7.2 million per year in California alone). But the MDS data alone cannot do more than predict the potential for problems, and intermittent surveys often lead to a “yo-yo” pattern of compliance, with concerns being corrected pending or immediately after a survey and conditions thereafter deteriorating. A recent HCFA study in California found that fewer than three percent of the 493 Los Angeles County skilled nursing facilities that accepted residents covered by Medicaid or Medicare were in full or substantial compliance with all applicable federal standards, with 19 percent having violations that caused actual harm or had the potential to cause death or serious injury to their residents. And, although California is leading the trend towards more vigorous enforcement, other states have begun to use MDS data to drive inspections as well, signaling a national trend which is top-of-mind for facility administrators nationwide.

Such widespread difficulties with operations compliance demonstrate that skilled nursing facility administrators are simply being overwhelmed with regulatory, business and staffing pressures. But by integrating their MDS data with a powerful and comprehensive ordering platform, CentraLink offers these facilities an innovative and highly desirable means to support quality care, manage compliance and optimize billing classifications. Specifically, when CentraLink discovers a potential discrepancy in the MDS data submitted from a given skilled nursing facility (for example, an untreated pressure ulcer), it automatically flags the area for consideration of appropriate corrective action (for example, a visit from the facility's wound care supplier).

Because the invention is both comprehensive and automatic, a facility that contracts for the inventive services and products can address any potential violations well before inspection occurs. In addition, the process flags potential deficiencies as early as possible (since the MDS must be submitted within five days after admission), when they are least expensive to remedy. Finally, by requiring facility approval for the proposed corrective action, the inventive system helps contracting intermediate healthcare administrators tightly focus their budgets while increasing volume for participating suppliers and service vendors—creating a win-win situation between facilities and their key suppliers.

In addition to vendor and facility compliance, customer satisfaction surveys can be undertaken periodically. As shown in FIG. 18, MDS information from a facility is used extensively to manage inventory, to monitor quality and compliance, to check outcome performance, both clinical and financial, and to analyze diagnoses and the resulting cost reimbursement.

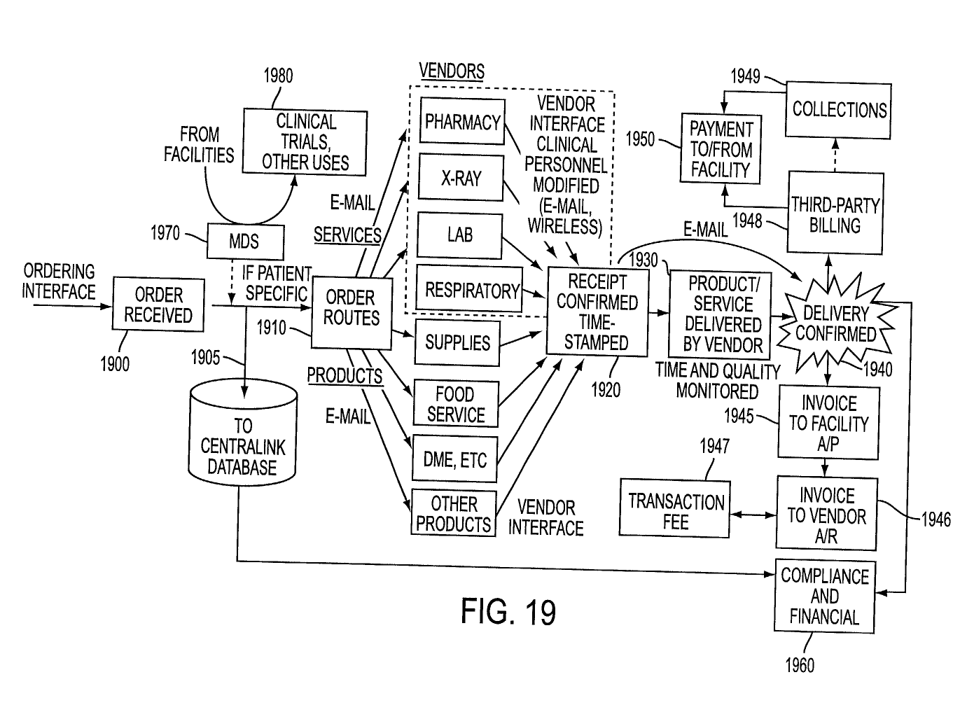

FIG. 19 is a block diagram of an exemplary Information Flow through a procurement process in accordance with one aspect of the invention. When an order is received (1900), the information from the order is placed in the central database (1905). The order is routed, typically using email, to the appropriate vendor. The vendor confirms receipt (1920) also, preferably by email. When the products or services are delivered by the vendor (1930) and the deliver confirmed (1940), the transaction is substantially complete. The facility is invoiced by the vendor (1945) and an entry made in their accounts payable record. Additionally, an invoice is generated in the accounts receivable column for the vendor. A transaction fee (1947) may be charged by the operator the Central Server for the services provided. When billings (1948) and collections (1949) may be handled by a third party or may be centralized as part of the Central Server activities. When payment is received from a facility or payment made to a vendor (1950), the appropriate records are made in the accounting system and money is appropriately transferred. When the delivery is made, compliance and financial information about the order are recorded (1960) and can be utilized in reports to the Intermediate Care Facility and to the vendor.

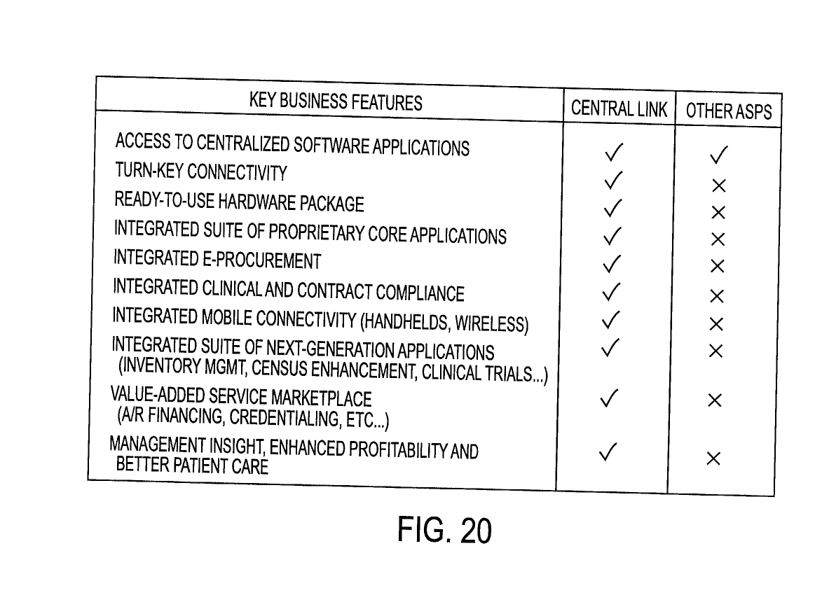

FIG. 20 is a comparison of selected features of the invention against application service providers of the prior art. Among healthservice service providers, no other company puts it all together like the inventive system. No other company offers an integrated, networked suite of management applications together with a turn-key connectivity package. No other healthcare ASP integrates e-procurement into their management applications, so no other company can offer the proactive operations compliance monitoring and clinical management features and integrated accounting and billing functions. In addition, since no other company starts out with a networked business model, no other company can offer the integrated and extended applications (e.g., mobile connectivity, improved materials management, etc . . . ) that the invention offers. These key market differentiators are illustrated in FIG. 20.

Although the present invention has been described and illustrated in detail, it is clearly understood that the same is by way of illustration and example only and is not to be taken by way of limitation, the spirit and scope of the present invention being limited only by the terms of the appended claims.

### Appendix A

### CD-ROM Contents

The following is a description of the contents of 3 CD-ROMs submitted as an appendix to this application:

### CD-ROM 1

This CD-ROM contains 2 Zipped Files. Each zipped file may be opened and the contents viewed using WinZip 7.0 from Nico Mak Computing Inc.

The first zipped file is 2001-08-25_{—}23-11-36_DB.zip which contains 3 “.dat” files comprising approximately 56 MBytes of uncompressed data. The “.dat” files may be opened and read using Microsoft SQL-2000 software.

The second zipped file is 2001-08-25_{—}23-11-36_VSS.zip. This zipped file contains 25,521 files comprising approximately 1.3 GBytes of uncompressed data. The extraction index can be viewed using WinZip 7.0. This files contains a variety of file types. The following is a list of file types and a description of how they may be opened/viewed.

| File Type | Open/View Using |
|---|---|
| .doc | Microsoft Word |
| .logs | Notepad |
| .a | temp tables used by Microsoft SQL-2000 |
| .b | temp tables used by Microsoft SQL-2000 |
| no extension | |
| .ini | Notepad |
| .tmp | not required |
| .gif | Almost any imaging software |

### CD-ROM 2

This CD-ROM contains 7 directories in a Microsoft file directory format. The Directories are:

| | |
|---|---|
| AP | Subdirectory-Utilities containing 6 files and |
| | 4.05 KBytes of data. |
| | 128 files and 1.32 Mbytes of data |
| AR2 | 647 files and 15.2 MBytes of data |
| GL_new | 169 files and 2.78 Mbytes of data |
| Li | 357 files and 7.55 Mbytes of data |
| Se | 277 files and 5.38 Mbytes of data |
| Spirit | 77 files and 5.23 Mbytes of data |
| Ut | 197 files and 7.63 Mbytes of data |

The following is a list of file types found in these directories, the subdirectory in which they first appear and a description of how they may be opened/viewed.

| File Type | Open/View Using | |
|---|---|---|
| in AP: | | |
| “file” | Notepad/Wordpad | These are Providex Programs |
| | | and need a PVX interpreter |
| | | to be loaded and read. (same) |
| .djd | same | |
| .pvx | same | |
| .old | same | |
| .con | same | |
| .trial | same | |
| .det | same | |
| .dhb | same | |
| In AR2: | | |
| .en | Nomads Library | |
| | interpreter | |
| .ldd | same | |
| .bvh | same | |
| .slp | same | |
| .opt | same | |
| .wch | same | |
| .ne | same | |
| .new | same | |
| In GL_new: | | |
| “bitmap image” | Almost any imaging | |
| | software | |
| In Li | | |
| .help | text | |
| .1st | same | |
| .cpy | same | |
| .921 | same | |
| .930 | same | |
| .mai | same | |
| html | Microsoft HTML | |
| | Document 5.0 | |
| chart | Microsoft Graph 97 | |
| .asp | same | |
| .V1 | same | |
| .V2 | same | |
| .001 | same | |
| In Se: | | |
| .dde | same | |
| .nmd | same | |
| In Spirit | (all covered previously) | |
| In Ut: | | |
| .utl | same | |
| .pub | same | |
| .bbx | same | |
| .sh | UNIX | |
| .cnv | same | |
| .c | same | |

### CD-ROM 3

This CD-ROM contains 3 Files comprising approximately 1.7 Mbytes. The following is a list of filesfound in these directories and a description of how they may be opened/viewed.

| File | Open/View Using |
|---|---|
| ALF Spec | Microsoft Powerpoint |
| ASP Design | Microsoft Word |
| Clinical_Raw_Code | The .xxx file should be renamed .zip and then |
| | read as indicated above. |

What is claimed is:

1. A method of providing services to an Intermediate Care Facilities (ICF) comprising the steps of:
a. providing a network of workstations at the Intermediate Care Facility;
b. connecting workstations on said network to a remote central server;
c. connecting one or more vendors to said central server; and
d. providing said workstations at the Intermediate Care Facility with access to only ones of said one or more vendors approved by said Intermediate Care Facility.

2. The method of claim 1 in which said network is a wireless network.

3. The method of claim 1 further comprising the step of providing a purchase order from said ICF to one or more of said vendors approved by said ICF.

4. The method of claim 1 further comprising the step of tracking vendor performance on each purchase order.

5. The method of claim 1 further comprising the step of providing reports to said ICF on vendor performance.

6. A method of upgrading information process capability at Intermediate Care Facilities, comprising the steps of:
a. providing workstations at an Intermediate Care Facility;
b. connecting said workstations to a network hub;
c. connecting said network hub to a central applications service provider.

7. The method of claim 6 in which said network hub is a wireless hub.

8. The method of claim 6 in which the applications service provider provides at least one application from the set of applications consisting of: Vendor Compliance Software, Electronic Procurement Software, Clinical Compliance Software, Clinical Assessment Software, Mobile Connectivity Software, Clinical Trials Software, Census Enhancement Software, MDS Manager Software, Physician Order Software.

9. The method of claim 8 in which the applications service provider further provides at least one application from the set of applications consisting of: Billing Software, Inventory Management Software, Accounts Payable Software, Accounts Receivable Software, Billing Software and Accounting and Financial Software.

10. A method of upgrading information processing capability at Intermediate Care Facilities, comprising the steps of:
a. providing workstations at an Intermediate Care Facility;
b. connecting said workstations to a central applications service provider that provides integrated clinical and procurement applications for the Intermediate Care Facility.

11. The method of claim 10 in which the applications service provider provides at least one application from the set of applications consisting of: Vendor Compliance Software, Electronic Procurement Software, Clinical Compliance Software, Clinical Assessment Software, Mobile Connectivity Software, Clinical Trials Software, Census Enhancement Software, MDS Manager Software, Physician Order Software.

12. The method of claim 10 in which the Intermediate Care Facility may select from a set of clinical and procurement applications and pay a fee based on the number and/or type of applications selected.

13. The method of claim 12 in which the fee is due periodically.

14. A server for connection to at least one Intermediate Care Facility, comprising:
a. a storage area network;
b. a plurality of application servers operating in a load sharing mode;
c. a network interface; and
d. a rules engine for processing information provided by one or more applications.

15. The server of claim 14 in which said rules engine drives one or more of said applications.

16. The server of claim 14 in which said rules engine links data and functions of one or more applications.

17. The server of claim 14 in which said rules engine comprises rules of a rules hierarchy in which rules inherit properties from other rules higher in the hierarchy.

18. The server of claim 14 in which said rules engine comprises rules having a scope of application that applies to an enterprise or subdivision of an enterprise, to facilities and to institutions.

19. The server of claim 14 adapted to be connected to one or more suppliers of goods or services.

20. The server of claim 14 in which said applications include one or more applications from the set of applications consisting of: Vendor Compliance Software, Electronic Procurement Software, Clinical Compliance Software, Clinical Assessment Software, Mobile Connectivity Software, Clinical Trials Software, Census Enhancement Software, Resident Scheduling, MDS Manager Software, Physician Order Software.

21. A method of processing information for use with clinical trials, comprising the steps of:
a. removing patient identifying information from a Minimum Data Set file to produce a revised file;
b. storing information from the revised file in a database; and
c. retrieving information from said database in response to a user query.

22. The method of claim 21 in which said user query is directed to identifying organizations having candidates for participation in a clinical trial.

23. The method of claim 21 in which said user query is directed to identifying organizations having candidates using a particular product or service.

24. A workstation for connection to a central server of an application service provider, said workstation comprising: a hidden copy of data and instructions comprising at least a portion of an application provided by said central server whereby said workstation can continue to provide functionality to users when a communication link to said central server is not operational.
